(19) United States
(12) Patent Application Publication
(10) Pub. No.: US 2016/0023751 A1
(43) Pub. Date: Jan. 28, 2016

(54) ENERGY HARVESTING MECHANISM FOR GYROPLANES AND GYROCOPTERS

(71) Applicant: The Board of Regents of the Nevada System of High- er Education on Behalf of the University of Nevad, Las Vegas, NV (US)

(72) Inventors: Joon Soo Lee, Henderson, NV (US); Woosoon Yim, Henderson, NV (US)

(21) Appl. No.: 14/810,821

(22) Filed: Jul. 28, 2015

Related U.S. Application Data
(60) Provisional application No. 62/029,613, filed on Jul. 28, 2014.

(51) Int. Cl. B64C 27/02; B64C 13/20; B64D 27/24; G05D 1/00; G05D 1/04; G05D 1/08; B64D 47/08; B64C 27/54

(52) U.S. Cl. CPC B64C 27/021; B64D 47/08; B64C 13/20; B64C 27/54; G05D 1/0011; G05D 1/042; G05D 1/0808; B64D 27/24

(57) ABSTRACT

An electric powered gyroplane or gyrocopter includes an airframe, a rotor assembly, an electric generator, a battery charger, one or more rechargeable batteries, a propulsion motor, a propulsion motor controller and a propeller. The rotor assembly is mounted to the airframe and includes a drive shaft mechanically coupled to a rotor hub, and two or more rotor blades extending radially outward from the rotor hub. The electric generator is mechanically coupled to the rotor assembly. The battery charger is electrically connected to the electric generator. The one or more rechargeable batteries are electrically connected to the battery charger. The propulsion motor controller is electrically connected to the one or more rechargeable batteries. The propulsion motor is connected to the propulsion motor controller. The propeller is mounted to the airframe and mechanically coupled to the propulsion motor.

### CROSS-REFERENCE TO RELATED APPLICATIONS

This application claims priority based on U.S. Provisional Application No. 62/029,613, filed Jul. 28, 2014. The contents of which is incorporated by reference in its entirety.

### INCORPORATION-BY-REFERENCE OF MATERIALS FILED ON COMPACT DISC

None.

### TECHNICAL FIELD OF THE INVENTION

The present invention relates in general to the field of power management, and more specifically to an energy harvesting mechanism for gyroplanes and gyrocopters.

### STATEMENT OF FEDERALLY FUNDED RESEARCH

None.

### BACKGROUND OF THE INVENTION

Without limiting the scope of the invention, its background is described in connection with gyroplanes and gyrocopters. Gyrocopter or gyroplane is designated by the Federal Aviation Administration (FAA) as an aircraft that gets lift from a freely turning rotary wing, or rotor blades, and derives its thrust from an engine-driven propeller. Two examples of gyroplanes are shown in FIG. 1A (an electrically powered model gyroplane) and FIG. 1B (a recreational manned gyroplane). Gyroplane 100 in FIGURE lA includes an airframe 102, a rotor assembly 104 mounted to the airframe 102, a propeller 106 mounted to the airframe 102 and mechanically coupled to a propulsion engine or motor 108, and a set of control surfaces (e.g., elevator 110, rudder 112, etc.). The rotor assembly 104 includes a drive shaft mechanically coupled to a rotor hub 114 and two or more rotor blades 116 extending radially outward from the rotor hub 114. Gyroplanes 100 derive lift from freely turning rotor blades 116 tilted back to catch the air. The rushing air spins the rotor assembly 104 as the aircraft 100 is pushed forward by an engine-driven propeller 106.

Now referring to FIG. 2, a block diagram of a conventional configuration 200 of an electric gyrocopter in accordance with the prior art is shown. The rotor assembly 104 includes a drive shaft 202 mechanically coupled to a rotor hub 114 and two or more rotor blades 116 extending radially outward from the rotor hub 114. The drive shaft 202 is mounted to the airframe so that the rotor blades 116 can rotate freely. The propeller 106 is mounted to the airframe and mechanically coupled to a propulsion motor 204, and provides thrust for the gyrocopter. The propulsion motor 104 is controlled by a propulsion motor controller 206 and powered by one or more batteries 208.

A gyroplane can fly more slowly than airplanes and will not stall. They can fly faster than helicopters but cannot hover. Since the rotor blades on the gyroplane are powered only by the air (autorotation), much like a windmill, there is no need for a tail rotor to provide anti-torque. The gyroplane is a stable flying platform. This is not so with helicopters, which pull the air down through engine-powered rotor blades making it possible to hover, but also making the aircraft very complicated and expensive to fly. Due to their inherent simplicity, gyroplanes are easier to operate and less expensive to maintain than helicopters.

### SUMMARY OF THE INVENTION

Gyroplanes and gyrocopters can be a more sustainable aerial platform in autonomous mode of operation using a novel on-board battery recharging system that can provide the power to either a main propulsion propeller or on-board sensor and communication systems needed for unmanned autonomous operations. The present invention solves the problem associated with the limited flight time by utilizing the “free” rotating rotor blades of the gyroplane during its flight. These free rotating rotor blades collect the wind's kinetic energy during both regular flight and gliding modes. The rotor is connected to a drive shaft that turns an electric generator to produce electricity and at the same time connected to the on-board battery charger and rechargeable battery used for the main propulsion motor. Although the present invention adds extra weight required for the electrical generator/charger connected to the free rotating rotor blade into a gyroplane and adds friction to the rotor during the charge by DC generator, these drawbacks are minor considering the additional power obtained from the rotor blade during a normal flight as well as in gliding flight mode, which can eventually extend the flight time.

For example, the present invention provides an electric powered gyroplane or gyrocopter that includes an airframe, a rotor assembly, an electric generator, a battery charger, one or more rechargeable batteries, a propulsion motor, a propulsion motor controller and a propeller. The rotor assembly is mounted to the airframe and includes a drive shaft mechanically coupled to a rotor hub, and two or more rotor blades extending radially outward from the rotor hub. The electric generator is mechanically coupled to the rotor assembly. The battery charger is electrically connected to the electric generator. The one or more rechargeable batteries are electrically connected to the battery charger. The propulsion motor controller is electrically connected to the one or more rechargeable batteries. The propulsion motor is connected to the propulsion motor controller. The propeller is mounted to the airframe and mechanically coupled to the propulsion motor.

In addition, the present invention provides a method in which an electric generator is driven using a rotor assembly mounted to an airframe of a gyroplane or gyrocopter that rotates when the gyroplane or gyrocopter moves, one or more rechargeable batteries are recharged using a battery charger connected to the electric generator, and a propeller mounted to the airframe is driven using a propulsion motor connected to the one or more rechargeable batteries controlled by a propulsion motor controller in block. The foregoing method can be implemented using a computer program embodied on a computer readable medium that cause a processor or system controller to perform the foregoing steps.

### BRIEF DESCRIPTION OF THE DRAWINGS

For a more complete understanding of the features and advantages of the present invention, reference is now made to the detailed description of the invention along with the accompanying figures and in which:

FIG. 1A is a photo of an electrical motor powered model gyroplane (Gyro-One Elettrico model) in accordance with the prior art;

FIG. 1B is a photograph of an engine powered manned Gyroplane model, Sportcoptor II by SportCoptor in accordance with the prior art;

FIG. 2 is a block diagram of a conventional configuration of an electric powered gyrocopter in accordance with the prior art;

FIG. 3 is a block diagram of an electric powered gyrocopter with generator and battery charger in accordance with one embodiment of the present invention;

FIG. 4 is photographs of an experimental set up in accordance with one embodiment of the present invention;

FIG. 5 is a graph of a current-voltage curve of the power generated by one embodiment of the present invention;

FIG. 6 is a graph of a power-voltage curve of the power generated by one embodiment of the present invention;

FIG. 7 is a block diagram of gyroplane or gyrocopter in accordance with another embodiment of the present invention;

FIG. 8 is a block diagram of a control scheme for wireless network based autonomous control of an unmanned gyroplane in accordance with one embodiment of the present invention;

FIG. 9 is an image of an example of telemetry by the proposed gyroplane in accordance with one embodiment of the present invention;

FIG. 10 is a flow chart of a method in accordance with one embodiment of the present invention; and

FIG. 11 is a flow chart of a method of controlling a flight of the gyroplane or gyrocopter in accordance with one embodiment of the present invention.

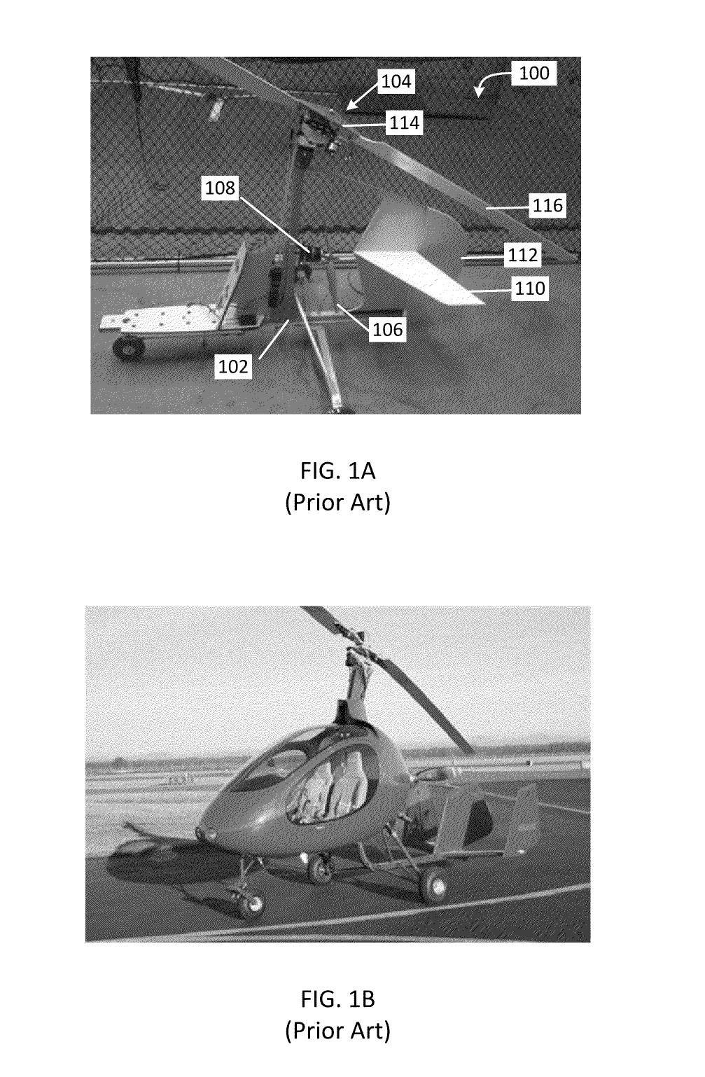

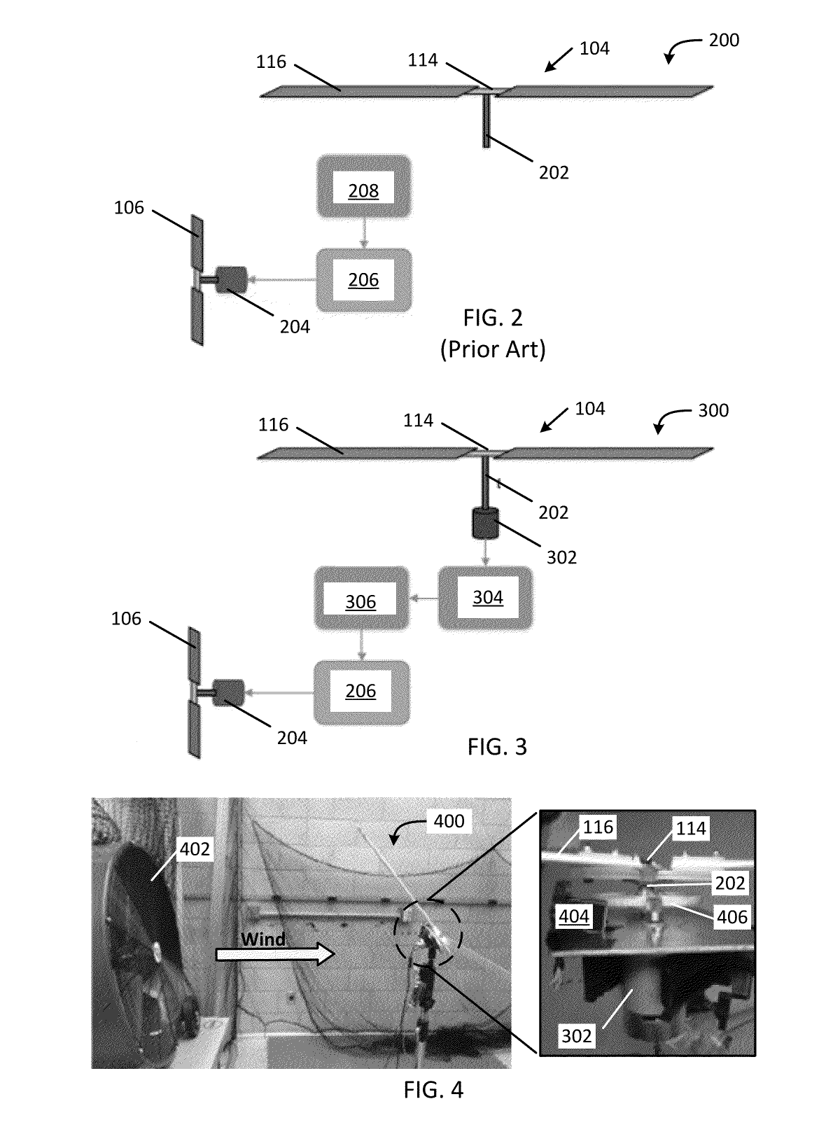

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Most of commercial manned gyroplanes use aircraft engines and are mainly used for recreational purpose for one or two persons. However, there is a great potential for smaller size unmanned autonomous gyroplanes that can be powered by an electrical motor. The unmanned electric gyroplanes can be used for autonomous surveillance and monitoring tasks in the areas that cannot be accessed by human. Currently, a limited flight time (<40 min) of popular multi-rotor helicopter based unmanned aerial platforms prevent their use in real life applications. The problem becomes worse when there is a heavy use of on-board flight/monitoring sensor package as well as different flight maneuvers.

Gyroplanes and gyrocopters can be a more sustainable aerial platform in autonomous mode of operation using a novel on-board battery recharging system that can provide the power to either a main propulsion propeller or on-board sensor and communication systems needed for unmanned autonomous operations. The present invention solves the problem associated with the limited flight time by utilizing the “free” rotating rotor blades of the gyroplane during its flight. These free rotating rotor blades collect the wind's kinetic energy during both regular flight and gliding modes. The rotor is connected to a drive shaft that turns an electric generator to produce electricity and at the same time connected to the on-board battery charger and rechargeable battery used for the main propulsion motor. Although the present invention adds extra weight required for the electrical generator/charger connected to the free rotating rotor blade into a gyroplane and adds friction to the rotor during the charge by DC generator, these drawbacks are minor considering the additional power obtained from the rotor blade during a normal flight as well as in gliding flight mode, which can eventually extend the flight time.

Now referring to FIG. 3, a block diagram of an electric powered gyroplane or gyrocopter 300 in accordance with one embodiment of the present invention is shown. The gyroplane or gyrocopter 300 includes an airframe, a rotor assembly 104, an electric generator 302, a battery charger 304, one or more rechargeable batteries 306, a propulsion motor 204, a propulsion motor controller 206 and a propeller 106. The rotor assembly 104 is mounted to the airframe and includes a drive shaft 202 mechanically coupled to a rotor hub 114, and two or more rotor blades 116 extending radially outward from the rotor hub 114. The electric generator 302 is mechanically coupled to the rotor assembly 104. The battery charger 304 is electrically connected to the electric generator 302. The one or more rechargeable batteries 306 are electrically connected to the battery charger 304. The propulsion motor controller 206 is electrically connected to the one or more rechargeable batteries 306. The propulsion motor 204 is connected to the propulsion motor controller 206. The propeller is mounted to the airframe and mechanically coupled to the propulsion motor 204.

Some preliminary data obtained from laboratory experiment is presented below. It should be noted that the experiment was done under the simulated wind conditions using a large fan 402 in the laboratory set up 400 as shown in FIG. 4. A drive shaft 202 is mechanically coupled to a rotor hub 114, and two or more rotor blades 116 extend radially outward from the rotor hub 114. The electric generator 302 is mechanically coupled to the drive shaft 202 via a set of gears 406. A RPM sensor 404 measures the rotation of the rotor blades 116. The following is description of instruments used for the experiment:

Generated power measurement device

Manufacturer: B&K Precision Corp.
Model Number: Model 8500

RPM measurement device 404

Manufacturer: UNLV
Photo interrupter and counter

DC Generator 302

Manufacturer: Mabuchi
DC motor
Model Number: RS-555PH
Operating voltage: 12 V DC

Fan 402

Manufacturer: MaxxAir
Model Number: BF30DD
Two speed (5500.3850 CFM)
⅓ HP, 30 inch, direct drive commercial fan

In this experiment, only two wind speeds of 8.5 MPH and 9.8 MPH are used. Typical gyroplanes start getting a lift force when the wind speed reaches 10 MPH. Considering that a typical gyroplane's speed can reach 60 MPH, the actual wind speed can be much higher during flight. Table 1 shows rotor rotation speeds in RPM when two different wind speeds of 8.5 MPH and 9.8 MPH. As shown in Table 1, there exists an average of 15% reduction in rotor speed mainly due to friction existing in DC generator 302 and gear train 406 shown in FIG. 4. It should be noted that DC generators 302 suitable for the present invention are currently available on the market with significantly lower friction.

TABLE 1

| | Without DC | With DC | Rotor Speed |
|---|---|---|---|
| Wind Speed | generator | generator | Reduction |
| 8.5 MPH | 333 RPM | 276 RPM | 17% |
| 9.8 MPH | 384 RPM | 330 RPM | 14% |

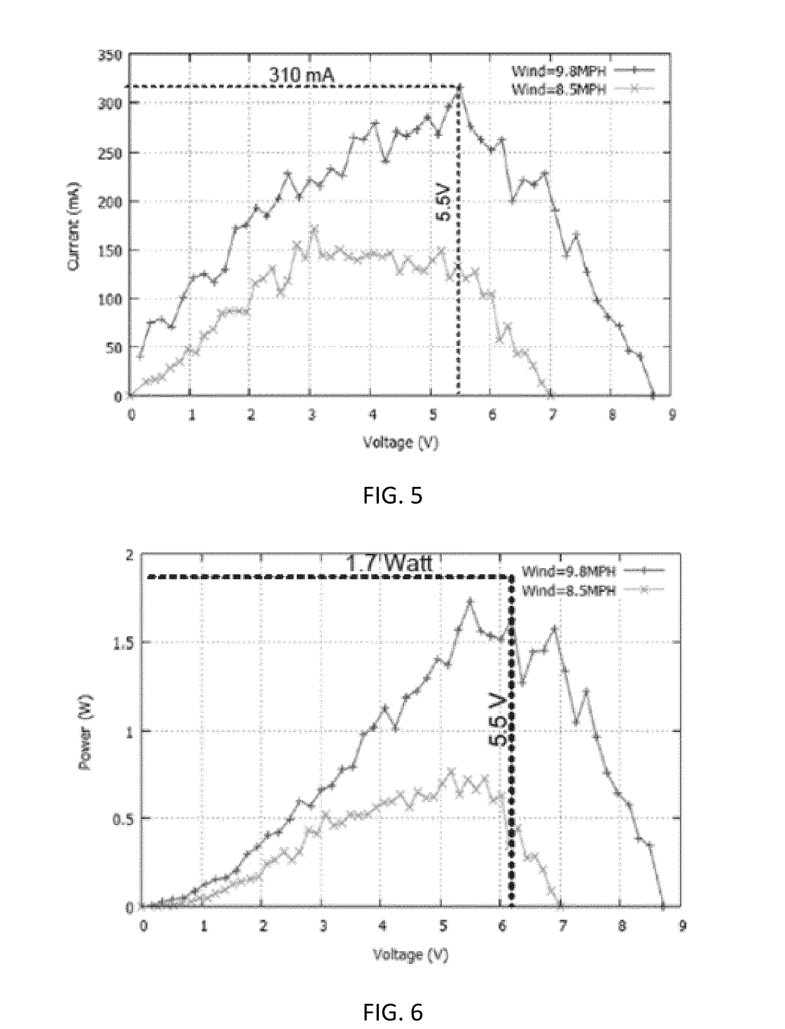

The power generated by these two different wind speeds is shown in FIGS. 5 and 6 (red=9.8 MPH; green=8.5 MPH). As expected, higher wind speed generated more power. The maximum voltage, current, and power generated are summarized in Table 2.

TABLE 2

| Wind Speed | Voltage | Current | Power |
|---|---|---|---|
| 8.5 MPH | 5.0 V | 140 mA | 0.8 W |
| 9.8 MPH | 5.5 V | 310 mA | 1.7 W |

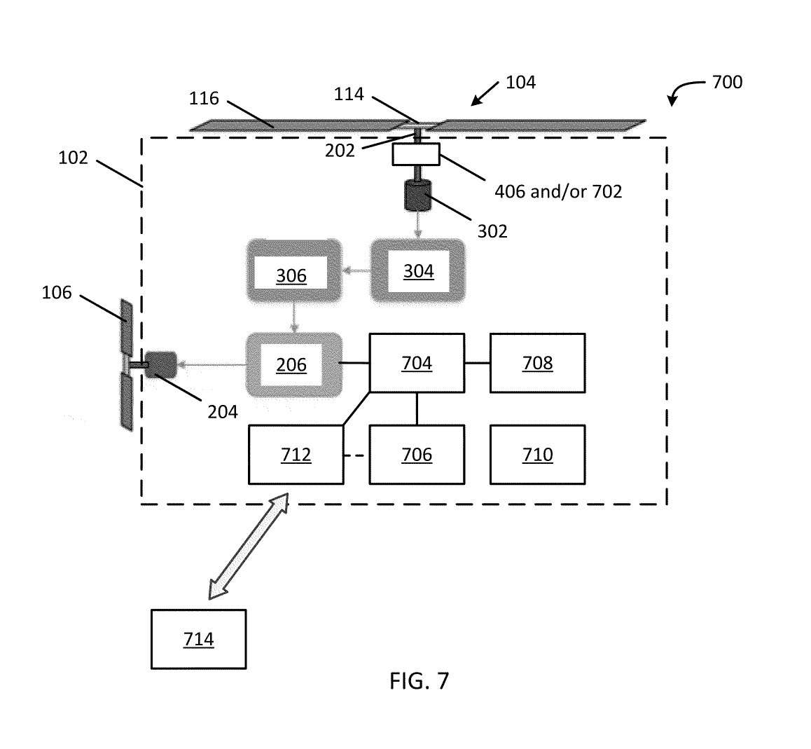

Referring now to FIG. 7, a block diagram of an electric powered gyroplane or gyrocopter 700 in accordance with one embodiment of the present invention is shown. The gyroplane or gyrocopter 700 includes an airframe 102, a rotor assembly 104, an electric generator 302, a battery charger 304, one or more rechargeable batteries 306, a propulsion motor 204, a propulsion motor controller 206, a propeller 106, a set of gears 406 and/or clutch 702, a controller 704, one or more sensors 706, one or more flight control surfaces 708, one or more electronic devices 710, and a wireless modem 712. The rotor assembly 104 is mounted to the airframe 102 and includes a drive shaft 202 mechanically coupled to a rotor hub 114, and two or more rotor blades 116 extending radially outward from the rotor hub 114. The rotor hub 114 is configured to tilt forward, aft, laterally or side-to-side. The rotor hub 114 may also include a swashplate assembly (not shown) that adjusts a position of the two or more rotor blades 116. The electric generator 302 is mechanically coupled to the rotor assembly 104 via a set of gears 406 and/or a clutch 702. The battery charger 304 is electrically connected to the electric generator 302. The one or more rechargeable batteries 306 are electrically connected to the battery charger 304. The propulsion motor controller 206 is electrically connected to the one or more rechargeable batteries 306. The propulsion motor 204 is connected to the propulsion motor controller 206. The propeller is mounted to the airframe 102 and mechanically coupled to the propulsion motor 204.

A system controller 704, such as a proportional-integral-derivative, is connected to the propulsion motor controller 206, one or more flight control surfaces 708, the one or more sensors 706 and the wireless modem 712. The system controller 704 may also be connected to one or more electronic devices 710. The wireless modem 712 can be directly connected to the one or more sensors 706 or obtain data from the one or more sensors 706 via the system controller 704. The one or more flight control surfaces 708 may include an aileron, an elevator, a flap, a rudder, etc., or a combination thereof. The one more sensors 706 may include a satellite navigation system, an altitude sensor, a gyro sensor, a gyro compass, an accelerometer, a RPM sensor, a radar, etc., or a combination thereof. The one or more electronic devices 710 may include a camera, a telecommunications repeater, a targeting system, a surveillance system, a mapping system, an electronic beacon, a laser, etc. or a combination thereof. The wireless modem 712 is communicably coupled to a remote controller 714 that monitors and controls the system controller and flight of the electric powered gyroplane or gyrocopter 700.

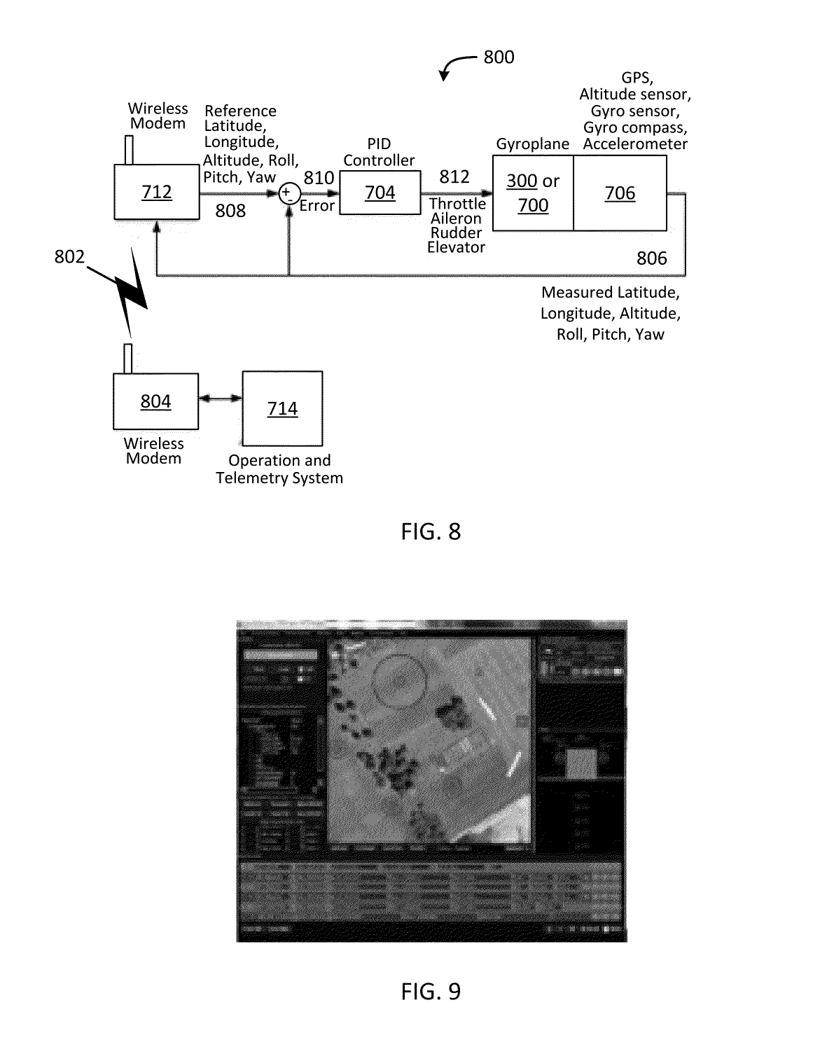

Now referring to FIG. 8, a block diagram of a control scheme 800 for wireless network based autonomous control of an unmanned gyroplane or gyrocopter 300 or 700 in accordance with one embodiment of the present invention is shown. The unmanned gyroplane or gyrocopter 300 or 700 can be either controlled by a radio controlled manual remote controller 714 or operated in an autonomous mode. In the manual mode, a remote controller 714 sends control signals 802 to the system controller 704 on board the unmanned gyroplane or gyrocopter 300 or 700 via a remote wireless modem 804 communicably coupled to the wireless modem 712 on board the unmanned gyroplane or gyrocopter 300 or 700. The control signals 802 provide commands to the system controller 704 to control the one or more flight control surfaces 708 (not shown) (e.g., servo drivers that drive the rudder, elevator, etc.), propulsion motor controller 206 (not shown) (e.g., servo drivers that throttle the motor, etc.) and any other devices or systems on board the unmanned gyroplane or gyrocopter 300 or 700. In the autonomous flight mode, feedback sensors are mounted to monitor flight behaviors of the gyroplane, and navigation data from gyro sensor and compass is used to stabilize the plane. GPS and other wireless networks are also needed for localization of the plane and transmitting telemetric data back to the main control station.

The flight of the gyroplane or gyrocopter 300 or 700 is controlled by measuring a latitude, a longitude, an altitude, a roll, a pitch and a yaw (collectively 806) using the one or more sensors 706, transmitting the latitude, the longitude, the altitude the roll, the pitch and the yaw (communication 802) to a remote controller 804 using the wireless modem 712, receiving a reference latitude, a reference longitude, a reference altitude, a reference roll, a reference pitch and a reference yaw (collectively 808) from the remote controller 804 using the wireless modem 712 (communication 802), computing an error 810 by comparing the latitude, the longitude, the altitude the roll, the pitch and the yaw (collectively 806) to the reference latitude, the reference longitude, the reference altitude, the reference roll, the reference pitch and the reference yaw (collectively 808), and adjusting 812 the one or more flight control surfaces 708 (not shown) and/or the propulsion motor 204 based on the error 810 using a system controller 704 (e.g., proportional-integral-derivative controller, etc.). An image of an example of telemetry by the proposed gyroplane in accordance with one embodiment of the present invention is shown in FIG. 9.

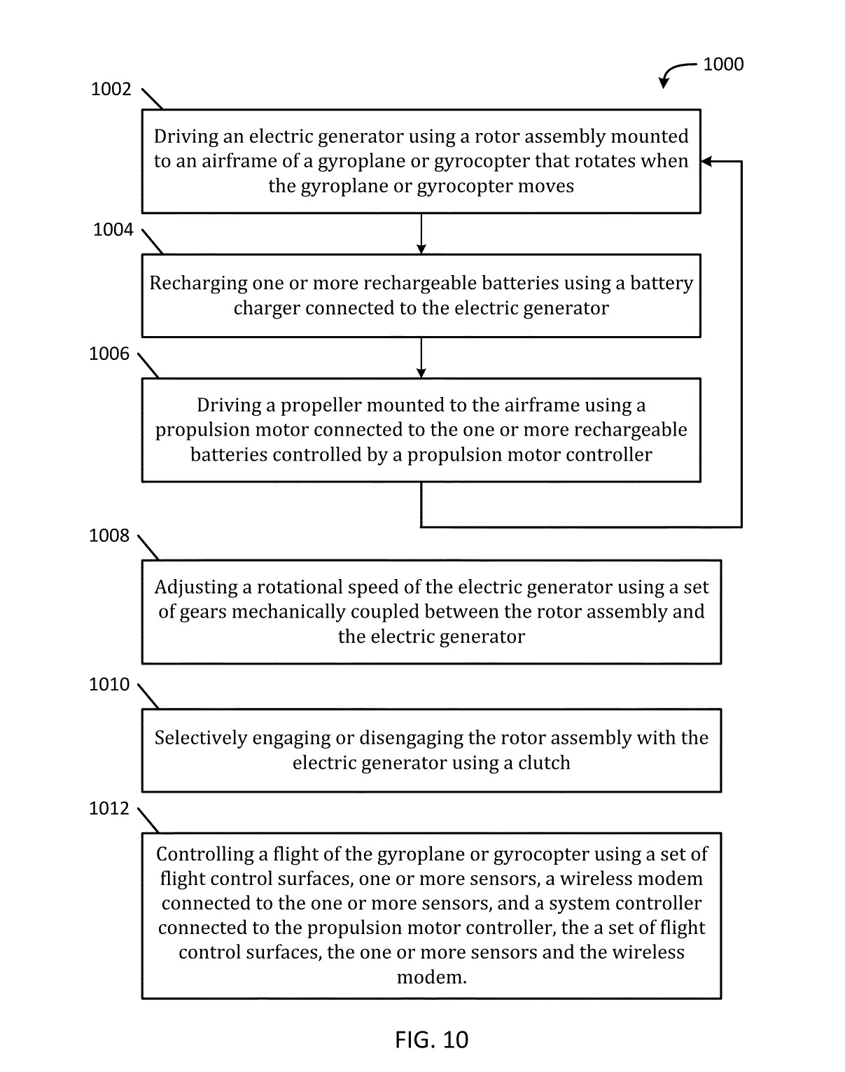

Referring now to FIG. 10, a flow chart of a method 1000 in accordance with one embodiment of the present invention is shown. An electric generator is driven using a rotor assembly mounted to an airframe of a gyroplane or gyrocopter that rotates when the gyroplane or gyrocopter moves in block 1002. One or more rechargeable batteries are recharged using a battery charger connected to the electric generator in block 1004. A propeller mounted to the airframe is driven using a propulsion motor connected to the one or more rechargeable batteries controlled by a propulsion motor controller in block 1006. As shown, the process is a continuous loop.

Additional steps may also be performed, such as adjusting a rotational speed of the electric generator using a set of gears mechanically coupled between the rotor assembly and the electric generator in block 1008, or selectively engaging or disengaging the rotor assembly with the electric generator using a clutch in block 1010, or controlling a flight of the gyroplane or gyrocopter using a set of flight control surfaces, one or more sensors, a wireless modem connected to the one or more sensors, and a system controller connected to the propulsion motor controller, the set of flight control surfaces, the one or more sensors and the wireless modem in block 1012. Note that connecting arrows are not shown to the blocks because they are optional and can be performed anytime during the method 1000.

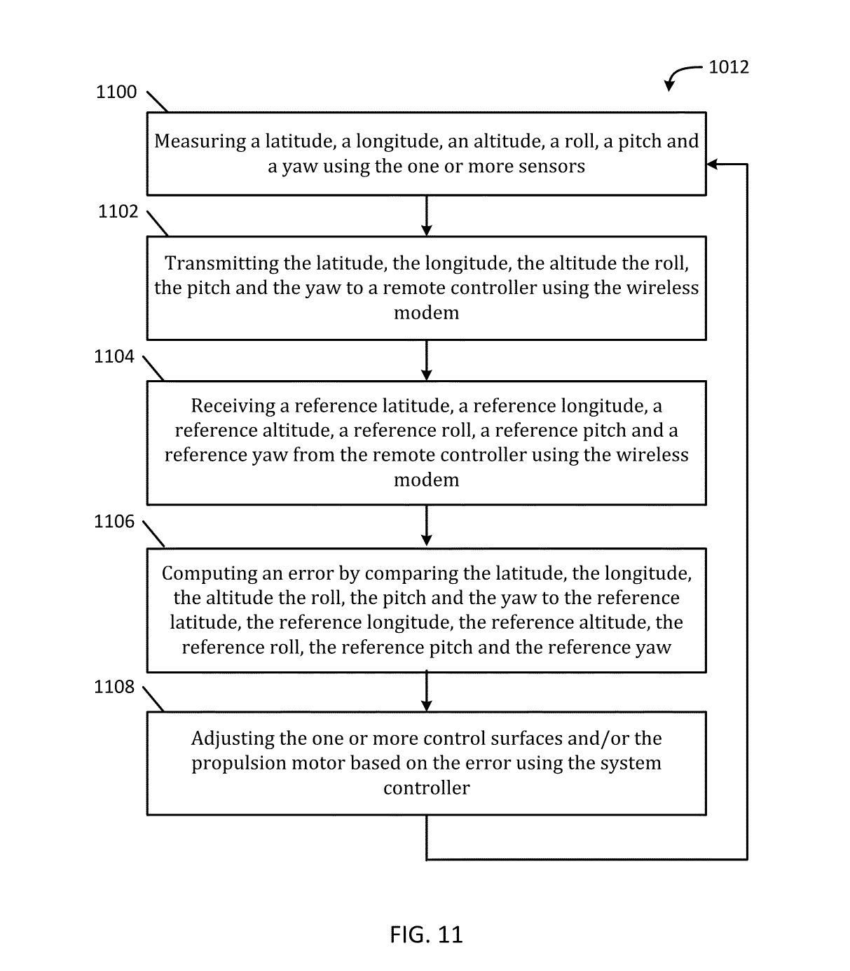

Now referring to FIG. 11, an example of a method 1012 of controlling a flight of the gyroplane or gyrocopter is shown. Controlling the flight of the gyroplane or gyrocopter may include measuring a latitude, a longitude, an altitude, a roll, a pitch and a yaw using the one or more sensors in block 1100, transmitting the latitude, the longitude, the altitude the roll, the pitch and the yaw to a remote controller using the wireless modem in block 1102, receiving a reference latitude, a reference longitude, a reference altitude, a reference roll, a reference pitch and a reference yaw from the remote controller using the wireless modem in block 1104, computing an error by comparing the latitude, the longitude, the altitude the roll, the pitch and the yaw to the reference latitude, the reference longitude, the reference altitude, the reference roll, the reference pitch and the reference yaw in block 1106, and adjusting the one or more control surfaces and/or the propulsion motor based on the error using the system controller in block 1108. As shown, the process is a continuous loop. The foregoing methods can be implemented using a computer program embodied on a computer readable medium that cause a processor or system controller to perform the foregoing steps.

The rotor based recharging system of the gyroplane in accordance with the present invention can be effectively used for the smart power management scheme of the unmanned autonomous aerial platform, which is crucial for real life applications of aerial platforms in surveillance and monitoring tasks. It should be noted that the invention is applicable for both regular and gliding modes of flight. The gliding flight is when the main propeller is not used for the thrust but there exists enough lift force generated by the rotor by rushing air. In this case, the gyroplane becomes a 100% windmill in the sky for recharging the battery used for the main thrust motor as well as other sensors and communication systems needed for autonomous navigation tasks. With a proper on-board smart power management scheme, the gyroplane can extend its flight time to achieve the goal of more sustainable aerial platform for real life applications.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications, patents and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A gyroplane or gyrocopter comprising:
an airframe;
a rotor assembly mounted to the airframe;
an electric generator mechanically coupled to the rotor assembly;
a battery charger electrically connected to the electric generator;
one or more rechargeable batteries connected to the battery charger;
a propulsion motor controller electrically connected to the one or more rechargeable batteries;
a propulsion motor connected to the propulsion motor controller; and
a propeller mounted to the airframe and mechanically coupled to the propulsion motor.

2. The gyroplane or gyrocopter as recited in claim 1, wherein the rotor assembly comprises a rotor hub and two or more rotors extending radially outward from the rotor hub.

3. The gyroplane or gyrocopter as recited in claim 2, wherein the rotor hub is configured to tilt forward, aft, laterally or side-to-side.

4. The gyroplane or gyrocopter as recited in claim 3, further comprising a swashplate assembly that adjusts a position of the two or more rotor blades.

5. The gyroplane or gyrocopter as recited in claim 1, further comprising a set of gears mechanically coupled between the rotor assembly and the electric generator.

6. The gyroplane or gyrocopter as recited in claim 1, further comprising a clutch selectively coupling the rotor assembly to the electric generator.

7. The gyroplane or gyrocopter as recited in claim 1, further comprising:
one or more sensors; and
a system controller electrically connected to the one or more sensors and the propulsion motor controller.

8. The gyroplane or gyrocopter as recited in claim 7, wherein the one or more sensors comprise a satellite navigation system, an altitude sensor, a gyro sensor, a gyro compass, an accelerometer, a radar or a combination thereof.

9. The gyroplane or gyrocopter as recited in claim 7, further comprising:
a set of flight control surfaces;
a wireless modem connected to the one or more sensors; and
a system controller connected to the propulsion motor controller, the one or more flight control surfaces, the one or more sensors and the wireless modem.

10. The gyroplane or gyrocopter as recited in claim 9, wherein the set of flight control surfaces comprise an aileron, an elevator, a flap, a rudder or a combination thereof.

11. The gyroplane or gyrocopter as recited in claim 9, further comprising one or more electronic devices electrically connected to the system controller.

12. The gyroplane or gyrocopter as recited in claim 11, wherein the one or more electronic devices comprise a camera, a telecommunications repeater, a targeting system, a surveillance system, a mapping system, an electronic beacon, a laser or a combination thereof.

13. The gyroplane or gyrocopter as recited in claim 1, wherein the gyroplane or gyrocopter is remotely controlled from a controller communicably coupled to the wireless modem.

14. A method comprising the steps of:
driving an electric generator using a rotor assembly mounted to an airframe of a gyroplane or gyrocopter that rotates when the gyroplane or gyrocopter moves;
recharging one or more rechargeable batteries using a battery charger connected to the electric generator; and
driving a propeller mounted to the airframe using a propulsion motor connected to the one or more rechargeable batteries controlled by a propulsion motor controller.

15. The method as recited in claim 14, further comprising the step of adjusting a rotational speed of the electric generator using a set of gears mechanically coupled between the rotor assembly and the electric generator.

16. The method as recited in claim 14, further comprising the step of selectively engaging or disengaging the rotor assembly with the electric generator using a clutch.

17. The method as recited in claim 14, further comprising the step of controlling a flight of the gyroplane or gyrocopter using a set of flight control surfaces, one or more sensors, a wireless modem connected to the one or more sensors, and a system controller connected to the propulsion motor controller, the a set of flight control surfaces, the one or more sensors and the wireless modem.

18. The method as recited in claim 17, wherein the step of controlling a flight of the gyroplane or gyrocopter comprising the steps:
measuring a latitude, a longitude, an altitude, a roll, a pitch and a yaw using the one or more sensors;
transmitting the latitude, the longitude, the altitude the roll, the pitch and the yaw to a remote controller using the wireless modem;
receiving a reference latitude, a reference longitude, a reference altitude, a reference roll, a reference pitch and a reference yaw from the remote controller using the wireless modem;
computing an error by comparing the latitude, the longitude, the altitude the roll, the pitch and the yaw to the reference latitude, the reference longitude, the reference altitude, the reference roll, the reference pitch and the reference yaw; and
adjusting the one or more flight control surfaces and/or the propulsion motor based on the error using the system controller.

19. The method as recited in claim 18, wherein the one or more sensors comprise a satellite navigation system, an altitude sensor, a gyro sensor, a gyro compass, an accelerometer, a radar or a combination thereof.

20. The method as recited in claim 18, wherein the set of flight control surfaces comprise an aileron, an elevator, a flap, a rudder or a combination thereof.
